(19) United States
(12) Patent Application Publication
(10) Pub. No.: US 2022/0380072 A1
(43) Pub. Date: Dec. 1, 2022

(54) Robotic Wrapping System

(71) Applicant: Idaho Forest Group LLC, Coeur d’Alene, ID (US)

(72) Inventors: Marc BRINKMEYER, Coeur d'Alene, ID (US); Chad KOSMICKI, Coeur d'Alene, ID (US); Jeremy FROMM, Coeur d'Alene, ID (US); Alex GOMEZ, Coeur d'Alene, ID (US)

(73) Assignee: Idaho Forest Group LLC, Coeur d?Alene, ID (US)

(21) Appl. No.: 17/825,556

(22) Filed: May 26, 2022

Related U.S. Application Data
(60) Provisional application No. 63/194,840, filed on May 28, 2021.

(51) Int. Cl. B65B 11/02; B25J 15/00; B25J 5/02; B25J 9/00; B65B 57/10; B65B 41/04

(52) U.S. Cl. CPC B65B 11/02; B25J 15/0066; B25J 5/02; B25J 9/0084; B25J 9/0093; B65B 57/10; B65B 41/04; B27F 7/38

(57) ABSTRACT

The technology disclosed relates a robotic workstation for packaging wood products. The robotic packaging workstation can achieve can handle efficiently wrapping/packaging product stacked into units. In one configuration, the robotic packaging workstation includes a robot manipulator capable of moving an end effector to points in a three-dimensional work volume under programed control of a programmable robot controller executing stored instructions. A fastener and wrapping tool head is affixed to the end effector adapter plate. The fastener and wrapping tool head further includes a support structure, a fastener applicator, a fastener storage, and a one or more grippers for grasping wrapping material.

### PRIORITY

This application claims the benefit of U.S. Provisional Patent Application No. 63/194,840, entitled, “ROBOTIC WRAPPING SYSTEM,” filed on May 28, 2021 (Atty. Docket No. IDFG 1008-1). The priority application is hereby incorporated by reference herein for all purposes.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves may also correspond to implementations of the claimed technology.

Processing timber involves a variety of tasks, such as sawing, packaging, and shipping product and the like. During processing, wooden logs are cut to various sizes in a timber mill or other facility and processed further into wood products, e.g., lumber, plywood, laminates, particle board and others. Once complete, the final product must be packaged up and shipped off facility for distribution and sale. Stacks or bundles of like product are wrapped with packaging material to prevent damage due to dirt or weather, prevent slippage and other benefits. Often, this wrapping is a manual operation performed by workers. There are many problems with these traditional approaches; the tasks involved in wrapping wood products can be repetitive and thus error prone; stacks and bundles of wood products can slip or spill presenting danger of inflicting injury to the worker or damaging the product. The lack of flexibility is also compounded by the complexity of materials handling requirements for the timber. Rough cut timber is heavy and unwieldy, making the job of moving it into and out of the work area complex.

Conventional approaches to the problem of packaging timber are not flexible, nor scalable, nor cost effective, and are of very low efficiency, making their usage in scalable timber processing installations problematic. Often, conventional approaches require a variety of different inflexible machines to perform the same task on different sizes and/or shapes of products. Sometimes, conventional approaches require additional energy to be expended moving timber among a larger variety of machines to perform processing.

An opportunity arises to develop better machines and processes for packaging wood products. Better, more easily operated, more effective and efficient apparatus and systems may result.

### SUMMARY

A simplified summary is provided herein to help enable a basic or general understanding of various aspects of exemplary, non-limiting implementations that follow in the more detailed description and the accompanying drawings. This summary is not intended, however, as an extensive or exhaustive overview. Instead, the sole purpose of this summary is to present some concepts related to some exemplary non-limiting implementations in a simplified form as a prelude to the more detailed description of the various implementations that follow.

The technology disclosed relates to a robotic workstation for packaging wood products. The robotic workstation can achieve efficiencies of scale and so forth, when packaging (e.g., wrapping, etc.) product stacked into so-named “units” having dimensions of approximately 40″ to 54″ in width, 12″ to 36″ height, and 6′ to 20′ in length. In one configuration, the robotic packaging workstation includes a plurality of robot manipulators arranged in tandem to work on product presented to the workstation. The manipulators are capable of moving an end effector to points in a three-dimensional work volume under programmed control of a programmable robot controller executing stored instructions. A fastener (e.g., staples, nails, brads, glues, or other non-threaded fasteners or screw drivers, or other threaded fasteners) and wrapping tool head is affixed to the end effector adapter plate. The fastener and wrapping tool head further includes a support structure, a fastener applicator, fastener storage, and one or more grippers for grasping wrapping material, a fastener low detection sensor and proximity switches.

An apparatus implementing the technology disclosed includes fastener and grasping tool for a robotic packaging workstation, that can include an adapter plate couplable to an end plate of a robot arm; a stapler having a tab feed mechanism for automatically feeding staples; a storage housing coupled to the stapler for dispensing staples; a stapler low detection proximity switch; and at least one mechanical gripper facilitating grasping of wrapping material.

In a particular implementation, the technology disclosed also provides a method of packaging (e.g., wrapping, etc.) product stacked into so-named “units” having dimensions of approximately 40″ to 54″ in width, 12″ to 36″ height, and 6′ to 20′ in length. The method can include receiving by a Programmable Logic Controller, information identifying a wood product unit to be received. The information can be received from a scanner, optical sensor(s), network connection or combinations thereof. The identifying information can include selected ones of a unit length, a unit width, a unit height, a unit ID, a product ID. The method further includes obtaining a portion of wrapping material appropriately sized using the identifying information. This can be achieved by at least a first plurality of robot manipulators grasping an end of the wrapping material, a motor with encoder feedback dispensing a length of wrapping material required to fully wrap the wood product unit, and at least a second plurality of robot manipulators grasping a trail end of the wrapping material prior to cutting the wrapping material. At least the first plurality of robot manipulators can (pre-)position themselves according to size of the wood product unit incoming based upon or using the identifying information. Alternatively, a detected or measured size of the wood product unit can be used. The wood product unit is received at a location determined by a presence sensor. The method can include determining by at least one robot manipulator a measured position of at least one corner of the wood product unit. The method also includes wrapping by the robot manipulators the wood product unit and applying fasteners to hold wrapping material in place. Upon completion of the wrapping, the wood product unit as packaged is advanced from an outfeed side of a work envelope using a materials handling system.

In one implementation, 4 robot manipulators (i.e., stapling and grasping tools) can wrap a unit of product working cooperatively. Various other combinations of product sizes and number of robotic manipulators can be implemented depending on requirements of the wood products processing facility.

Particular aspects of the technology disclosed are described in the claims, specification and drawings.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 illustrates a plan view of a robotic workstation for packaging wood products.

FIG. 2 illustrates a section view of a robotic workstation for packaging wood products.

FIG. 3 illustrates a left-side (infeed) view of a robotic workstation for packaging wood products.

FIG. 4A illustrates a left perspective view of a left side end effector tool robotic workstation for packaging wood products.

FIG. 4B illustrates a left side view of a left side end effector tool robotic workstation for packaging wood products.

FIG. 4C illustrates a plan view of a left side end effector tool robotic workstation for packaging wood products.

FIG. 4D illustrates a side view of a left side end effector tool robotic workstation for packaging wood products.

FIG. 5A illustrates a left perspective view of a right side end effector tool robotic workstation for packaging wood products.

FIG. 5B illustrates a left side view of a right side end effector tool robotic workstation for packaging wood products.

FIG. 5C illustrates a plan view of a right side end effector tool robotic workstation for packaging wood products.

FIG. 5D illustrates a side view of a right side end effector tool robotic workstation for packaging wood products.

FIG. 6 illustrates a flowchart of a process for packaging wood products.

FIGS. 7A, 7B, 7C, and 7D illustrate composite, plan, front and perspective views of an example end effector for group 3 robot 13 of FIG. 1.

FIGS. 8A, 8B, 8C, and 8D illustrate composite, plan, front and perspective views of an example end effector for group 2 robot 12 of FIG. 1.

FIGS. 9A and 9B show implementation of an electronics architecture used by the robot in which a controller processes input data comprising at least actuation data from the actuators of the actuation system, image data from visual sensors in the robot, and tactile data from tactile sensors in the robot, and generates actuator command data.

### DETAILED DESCRIPTION

The following description will typically be with reference to specific structural embodiments and methods. It is to be understood that there is no intention to be limited to the specifically disclosed embodiments and methods but that other features, elements, methods and embodiments may be used for implementations of this disclosure. Preferred embodiments are described to illustrate the technology disclosed, not to limit its scope, which is defined by the claims. Those of ordinary skill in the art will recognize a variety of equivalent variations on the description that follows. Unless otherwise stated, in this application specified relationships, such as parallel to, aligned with, or in the same plane as, mean that the specified relationships are within limitations of manufacturing processes and within manufacturing variations. When components are described as being coupled, connected, being in contact or contacting one another, they need not be physically directly touching one another unless specifically described as such. Like elements in various embodiments are commonly referred to with like reference numerals.

A more sophisticated robotic packaging system and method is provided for improved efficiency in packaging processed wood products. Implementations efficiently wrap product stacked into so-named “units” having dimensions of approximately 40″ to 54″ in width, 12″ to 36″ height, and 6′ to 20′ in length. Prior to wrapping, the relevant information pertaining to the unit of lumber is passed along to the wrapping programmable logic controller (PLC), including a unit length, a unit width, a unit height, a unit ID, a product ID, and potentially others. While the product is traversing the sawmill floor into the robotic packaging workstation, the programmable logic controller utilizes this unit dimensional information to command robot manipulators comprising the robotic workstation to obtain the appropriately sized (correct width) wrapping material (e.g., paper, bubble wrap, woven polypropylene, or the like).

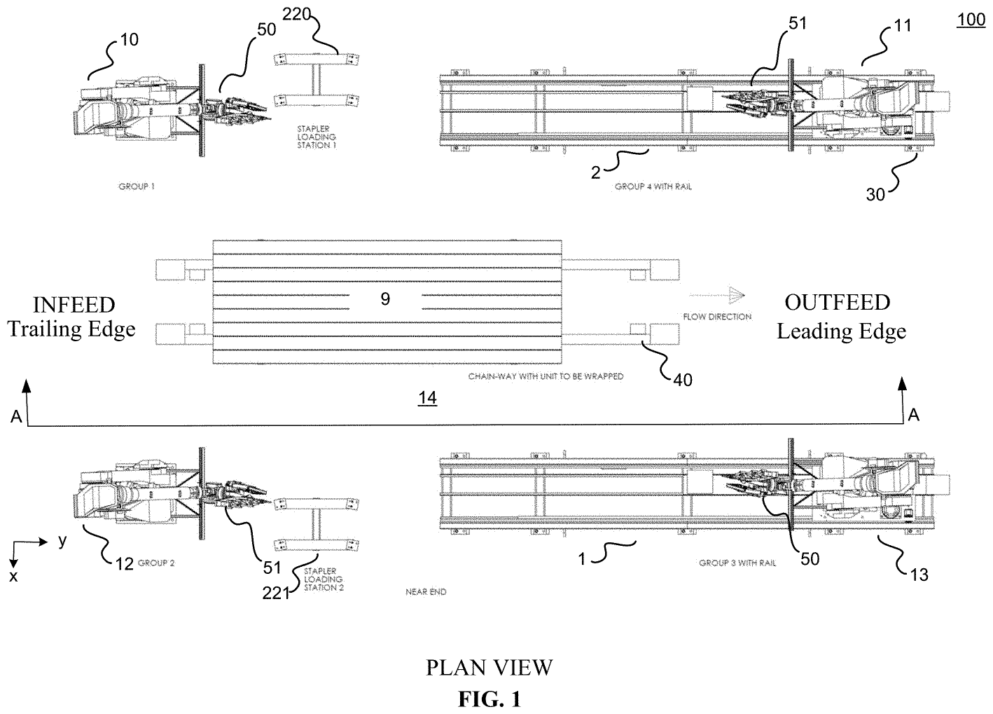

FIG. 1 illustrates a plan view 100 of a robotic workstation 14 for packaging wood products.

Robotic workstation 14 nominally includes a plurality of robot manipulators 10, 11, 12 and 13 (hereafter “robots” or “robot manipulators” or “manipulators” or “arms”) arranged into a leading edge group comprising robots manipulators 11 and 13 and a trailing edge group comprising manipulators 10 and 12; the arrangement being relative to a materials handling system 40 (conveyor or the like) that “feeds” product (e.g., unit 9) through the workstation 14 along a roughly linear path approximately bisecting the workstation 14.

Robot manipulators 10, 11, 12 and 13 can include a base 3 enabling the robot to be affixed to the sawmill floor directly or via a platform 2 to facilitate travel of the robot manipulator in order to process different sizes and/or shapes of product 9. In one implementation, base 3 comprises an M710 BASE 13.5. In the layout illustrated by FIG. 1, leading edge group manipulators 11 and 13 are mounted to a platform 2 nominally comprising two (2) linear rails of nominally 3.5 m in length, that enables the robots 11 and 13 to move along the y-direction of FIG. 1 in order to accommodate different sizes of product 9.

A robot controller (not shown in FIG. 1 for clarity sake) controls the motions of robot manipulators 10, 11, 12 and 13 under direct operator control and/or by programmed logic. Implementation specifics vary considerably, however in one example a Controllogix™ PLC is used to implement the robot controller.

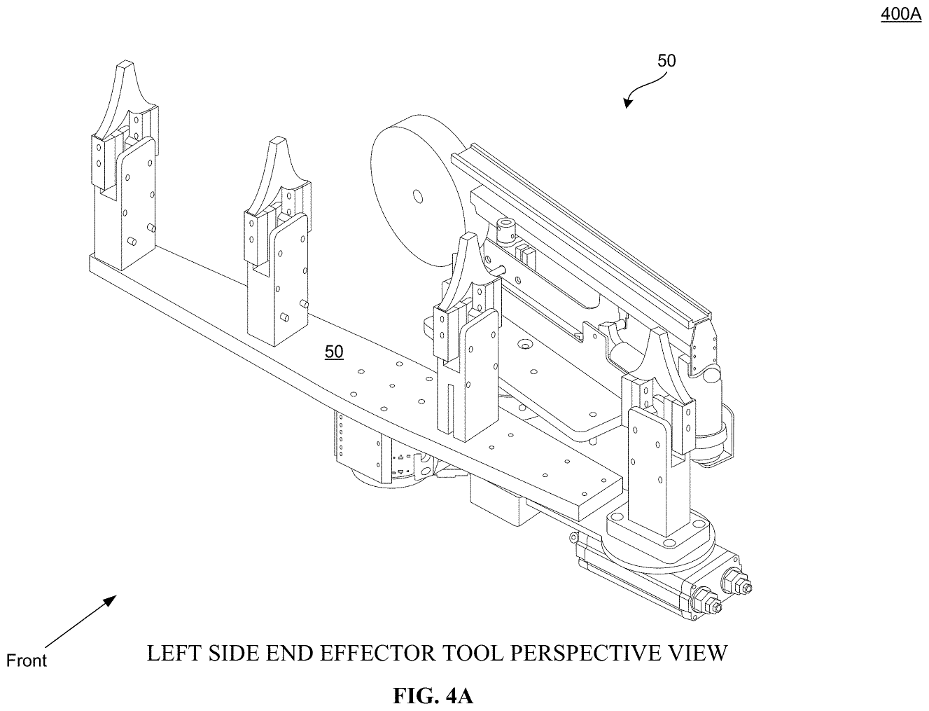

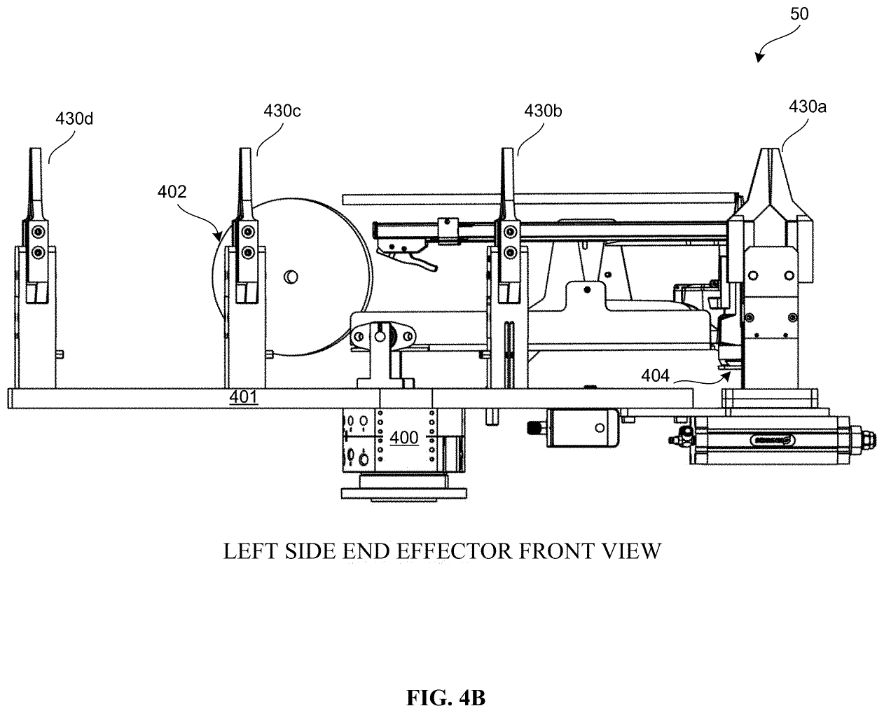

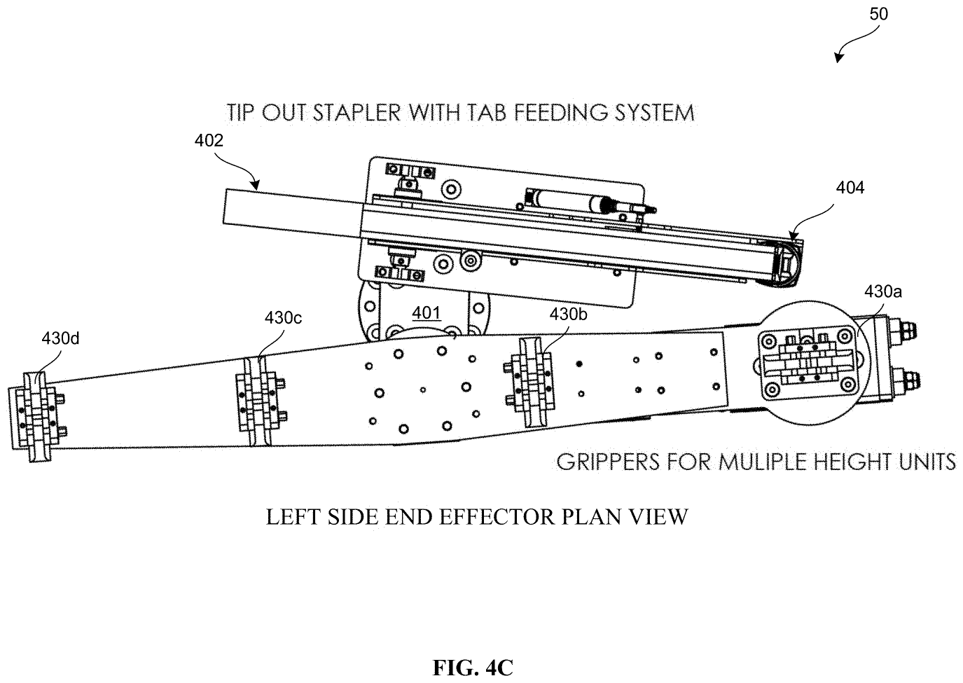

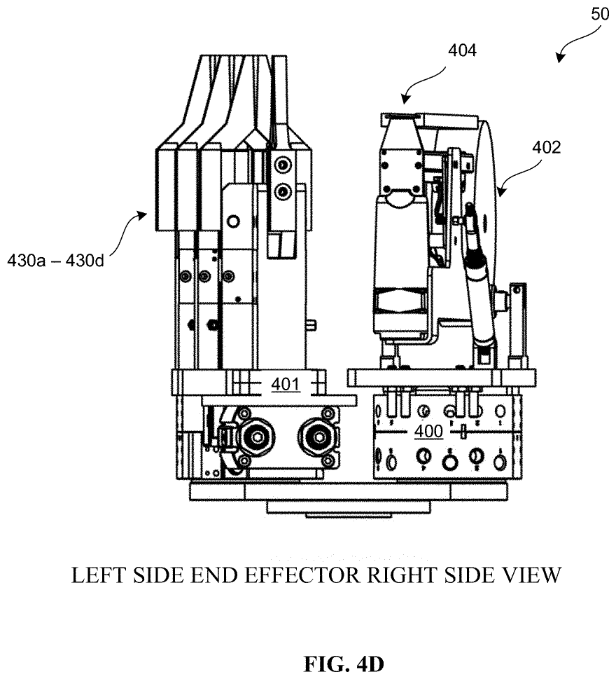

An end effector tool 50, 51 is coupled to the robot manipulators 10, 11, 12, and 13 and are able to be moved within the work envelope of the robot to which it is mounted in order to wrap product (e.g., unit 9) fed by materials handling system 40 under control of the robot controller. Preferable end effector tool implementations embody staple mechanism(s), staple feed mechanisms, gripper(s) for grasping wrapping material(s) etc., sensors and proximity switches. End effector tools 50, 51 are described in detail hereinbelow with reference to examples illustrated by FIGS. 4A-4D, FIGS. 7A-7D and FIGS. 5A-5D, FIGS. 8A-8D, respectively.

Robot manipulators 10, 11, 12, and 13 are preferably an industrial grade articulating robot arms (manipulators) capable of moving laterally approximately +/−4 feet from a starting position. Implementations efficiently wrap product stacked into so-named “units” having dimensions of approximately 40″ to 54″ in width, 12″ to 36″ height, and 6′ to 20′ in length. In one implementation, a highly customized FANUC M-710C 45M robotic arms implement robot manipulators 10, 11, 12, and 13. In one implementation, robot manipulator 10 includes feedback from servos that drive motions of the robot, such as torque, arbor speed, robot force exerted, collision detection and others. Other implementations can be realized using any of a number of industrial-purpose commercially available robots made by Fanuc, ASEA, Kuka, ABB, Yaskawa and the like.

Material handling system 40 preferably includes chain-way, conveyors, indexers, and the like to move units of product 9 into the workstation 14 and to move packaged units of product 9 out of the workstation 14.

Tool stations 220, 221 provide locations for end effector tools 50, 51 to be picked up by and dropped off by the robot manipulators 10, 11, 12, and 13 In a presently preferrable configuration, each one of the robot manipulators 10, 11, 12, and 13 can swap fastener tools at the tool stations 220, 221, either at the same time or individually. Tool stations 220, 221 can implement stapler refilling in some implementations. Robot manipulators 10, 11, 12, and 13 can drop off an end effector tool 50, 51 when a sensor indicates that the particular tool is low/out of staples and pick up a freshly loaded end effector tool. Once a stapler is refilled, it is put in the ‘Full’ Area. A proximity sensor (not shown in FIG. 1 for clarity sake) detects the presence of a refilled stapler and indicates to the appropriate robot that there is one ready for it to grab.

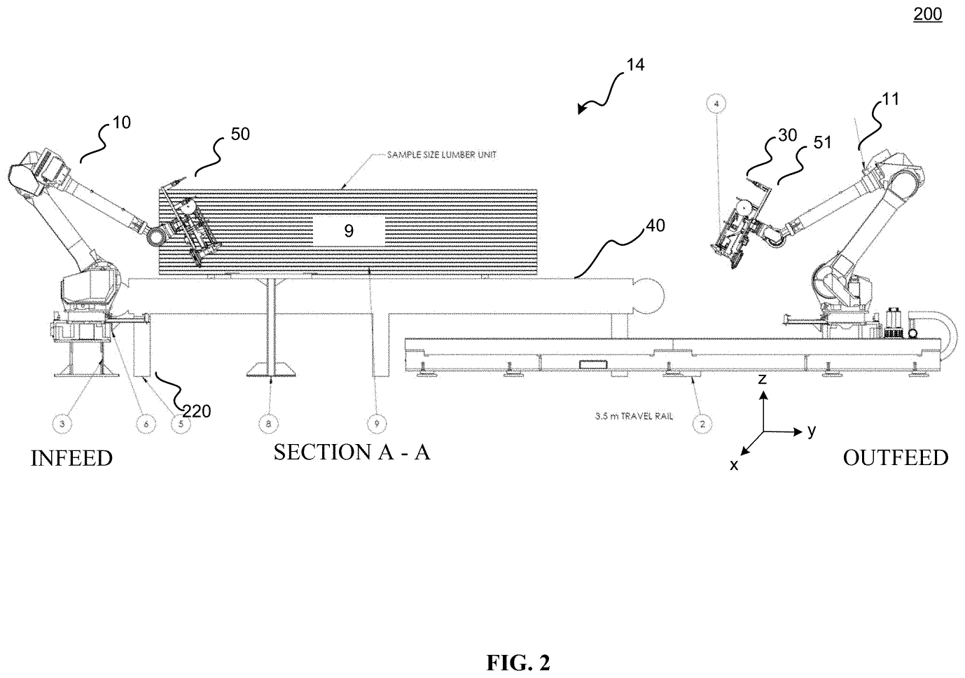

FIG. 2 illustrates a section view 200 of section A-A a robotic workstation for wrapping wood products. In section A-A view 200 of the robotic workstation 14, robot 11 of the leading edge group comprising robots manipulators 11 and 13 and a robot 10 of the trailing edge group comprising manipulators 10 and 12 are depicted at the outfeed side and the infeed side of the workstation 14. Also shown is material handling system 40 and example of wood product unit 9.

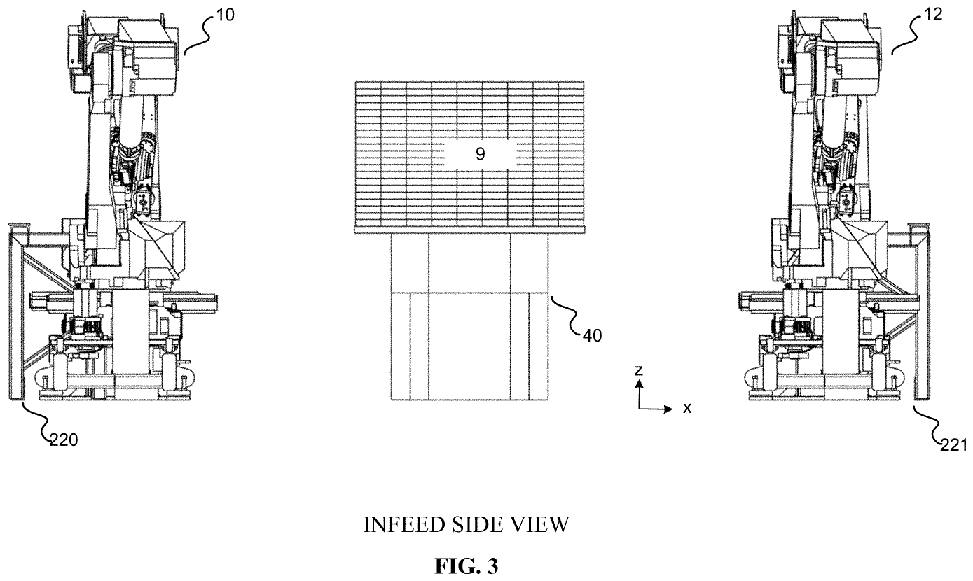

FIG. 3 illustrates a left-side (infeed) view of a robotic workstation for packaging wood products. In left side view 300 of the robotic workstation 14, robot 10 and 12 of the trailing edge group comprising manipulators 10 and 12 are depicted at the infeed side of the workstation 14. Also shown is material handling system 40 and example of wood product unit 9. Tool stations 220, 221 are also shown.

FIG. 4A illustrates a left perspective view of a left side end effector tool robotic workstation for packaging wood products.

FIG. 4B illustrates a left side view of a left side end effector tool robotic workstation for packaging wood products. In a presently preferrable configuration, groups 1, 2, 3, and 4 will use end effectors individual to that group. Fastener tools will be similar between right side group 1, 3 and left side group 2, 4. End effector tool 50 includes an adapter plate couplable to an end plate of a robot arm via tool changes 400; a support structure 401, a stapler (or other fastener dispenser) 404 having a tab feed mechanism for automatically feeding staples or other fasteners; a storage housing 402 coupled to the stapler 404 for dispensing staples or other fasteners; a stapler (or other fastener) low detection proximity switch (not shown in FIG. 4B); and one or more mechanical grippers 430a-430d facilitating grasping of wrapping material. Implementations can be configured to include one or more of a vacuum actuated gripper, an adhesive gripper, a magnetic gripper, a servo (electric) gripper, hydraulically actuated gripper, a pneumatically actuated gripper or combinations thereof. In a presently preferrable implementation, motion and actuation on the end effector depicted in FIG. 4B is pneumatically controlled. Fastener types implemented can include, e.g., staples, nails, brads, glues, or other non-threaded fasteners or screw drivers, or other threaded fasteners. Optionally, multiple grippers can be included to accommodate different heights of wood product units.

In left side view of left side end effector tool 50 for the leading group 3 robot 13 is shown.

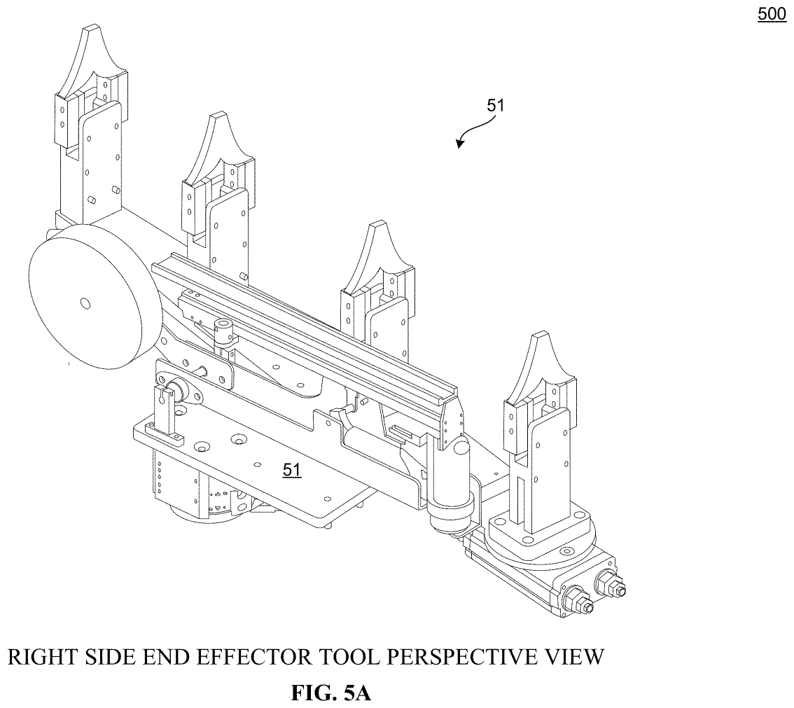

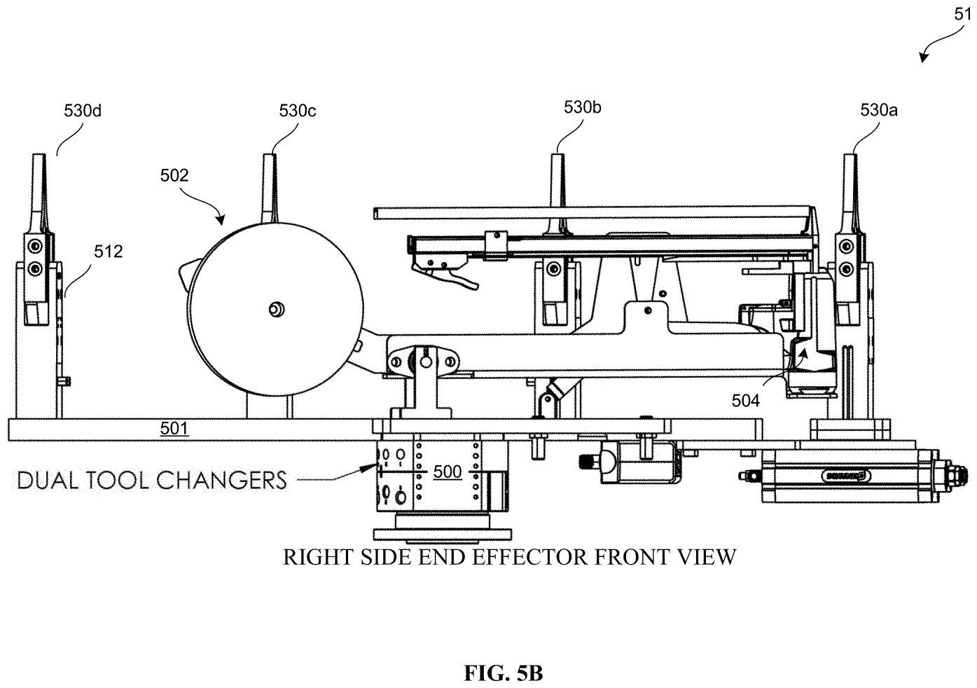

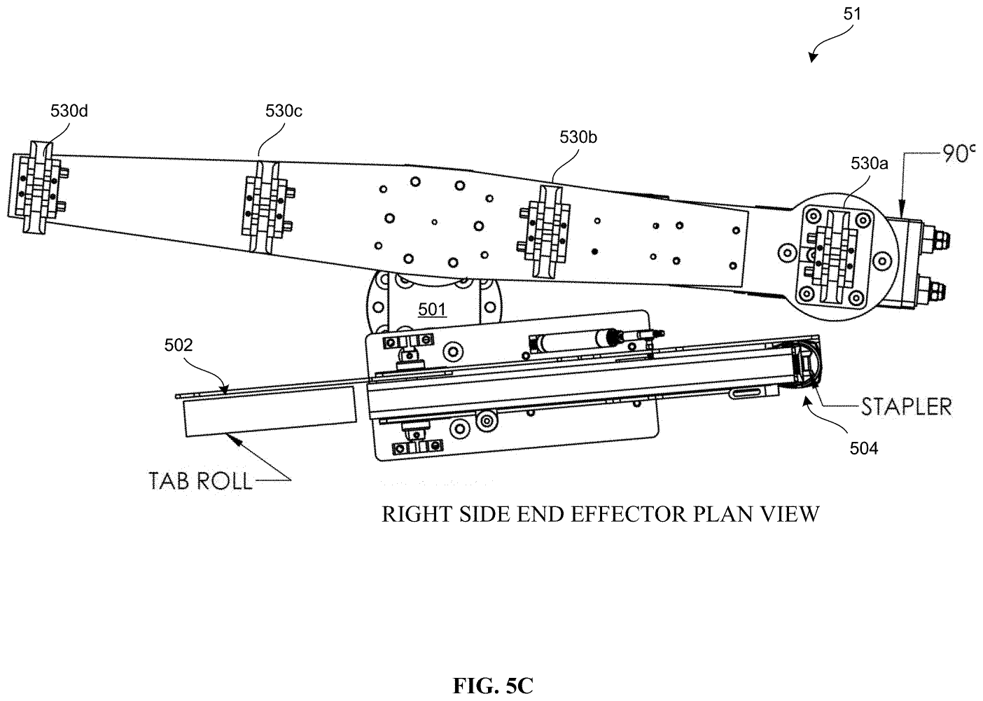

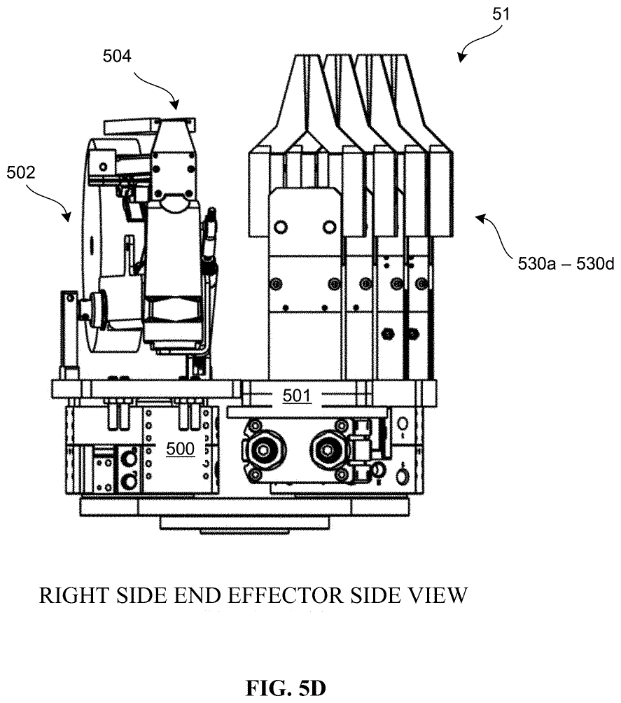

FIG. 4C illustrates a plan view of a left side end effector tool robotic workstation for packaging wood products. Left side end effector 50 includes support structure 401 couplable to an end effector adapter plate via tool changers (not shown in FIG. 4C) and supporting, stapler 404, storage housing 402 and grippers 430a-430d. Noteworthy comparing FIG. 4C and FIG. 5C is that at least one gripper 430a is capable of rotating 90 degrees; thereby facilitating grasping packaging materials in a variety of positions.

FIG. 4D illustrates a side view of a left side end effector tool robotic workstation for packaging wood products.

FIG. 5A illustrates a left perspective view of a right side end effector tool robotic workstation for packaging wood products.

FIG. 5B illustrates a left side view of a right side end effector tool robotic workstation for packaging wood products. A fastener (e.g., staples, nails, brads, glues, or other non-threaded fasteners or screw drivers, or other threaded fasteners) and wrapping tool head 51 is affixed to the end effector adapter plate via tool changes 500. The fastener and wrapping tool head further includes a support structure 501, a fastener applicator 504, fastener storage 502, and one or more grippers 530a-530d for grasping wrapping material driven by drive mechanism 512, and some fastener low detection sensor and proximity switches (not shown in FIG. 5B). Implementations can be configured to include one or more of a vacuum actuated gripper, an adhesive gripper, a magnetic gripper, a servo (electric) gripper, hydraulically actuated gripper, a pneumatically actuated gripper or combinations thereof In a presently preferrable end effector configuration, fastener tooling from groups 1 and 3 is the same, and that of groups 2 and 4 is also the same. In some configurations, tooling for each group is built using the like components in different configurations that are individual to each group. Fastener types implemented can include, e.g., staples, nails, brads, glues, or other non-threaded fasteners or screw drivers, or other threaded fasteners. Optionally, multiple grippers can be included to accommodate different heights of wood product units.

FIG. 5C illustrates a plan view of a right side end effector tool robotic workstation for packaging wood products. Right side end effector 51 includes support structure 501 couplable to an end effector adapter plate via tool changers (not shown in FIG. 5C) and supporting, stapler 504, storage housing 502 and grippers 530a-530d. Noteworthy comparing FIG. 4C and FIG. 5C is that at least one gripper 530a is capable of rotating +/−90 degrees; thereby facilitating grasping packaging materials in a variety of positions.

FIG. 5D illustrates a side view of a right side end effector tool robotic workstation for packaging wood products.

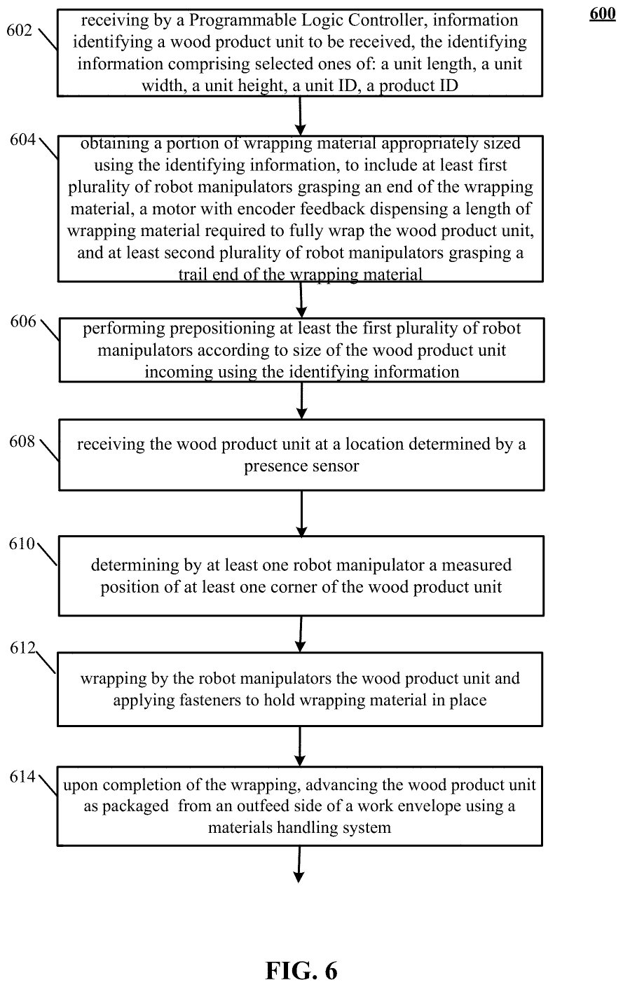

FIG. 6 illustrates a flowchart of a packaging process for wood products and other units of products.

In a step 602, after unit is strapped, the relevant information identifying the product (e.g., pertaining to the unit of lumber) is received by the Wrapping PLC System. Identifying information can comprise selected ones of: a unit length, a unit width, a unit height, a unit ID, a product ID, others.

In a step 604, the unit is advanced toward the paper dispensing station. While the unit is traversing, the Wrapping PLC System utilizes the Unit Dimensional Information to obtain the appropriately sized wrapping material (e.g., paper, bubble wrap, woven polypropylene or the like) of the correct width. Once the leading two robots (11, 13) grab the end of the paper, a motor with encoder feedback dispenses the length of paper required to fully wrap the incoming unit. The trailing two robots (10, 12) then grab the trail end of the paper and it is cut. In a presently preferrable configuration, the lumber wrap feed mechanism is separate from the robots being controlled by the same PLC. The wrapping material is fed and cut from a modified overhead feeder. Existing lumber wrap feed and cutting mechanisms may be modified for the space and control requirements of the robots. Some implementations include modifications made to existing equipment that is already in place and being used in manual lumber wrapping.

In a step 606, robots 11, 13 preposition themselves in the wrapping location for the incoming unit (location depends on unit length).

In a step 608, the Unit of product 9 comes in and stops at the same location (+/−3″) as determined by a Photo Array, optical array, or other non-tactile presence sensor or pressure or presence or other tactile sensor.

In a step 610, Near End Robots (12, 13) make a pass above the unit of product 9 to determine the exact location of the corner of the unit. This passes an offset for all dimensional movements of the robots to precisely know the location of all points.

In a step 612, the four robots then begin the wrapping process substantially contemporaneously in time. At folding points of the wrapping material, a staple is fired through a custom plastic tab and into the unit securing the wrapping material to the unit.

In a step 614, upon completion of the wrapping process, the unit advances out of the area and the sequence is reset for the next unit.

In one implementation, an average cycle time, independent of unit size, of approximately 1 min and 15 seconds from time unit stops in wrapping position.

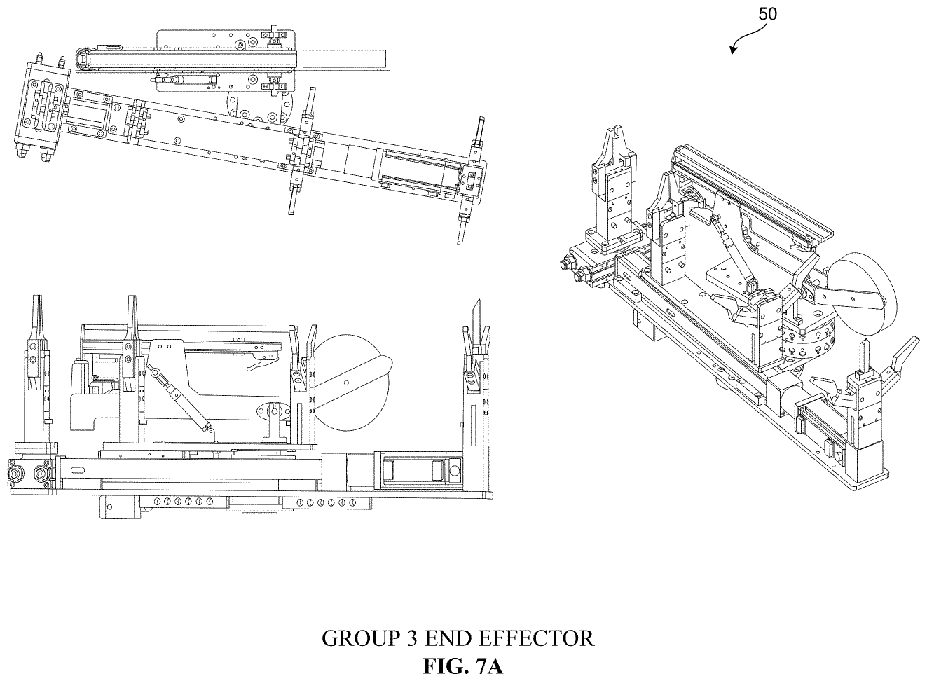

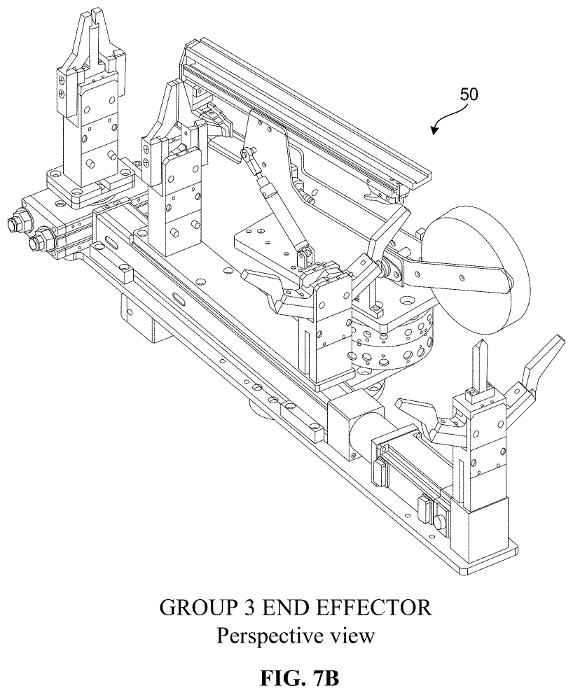

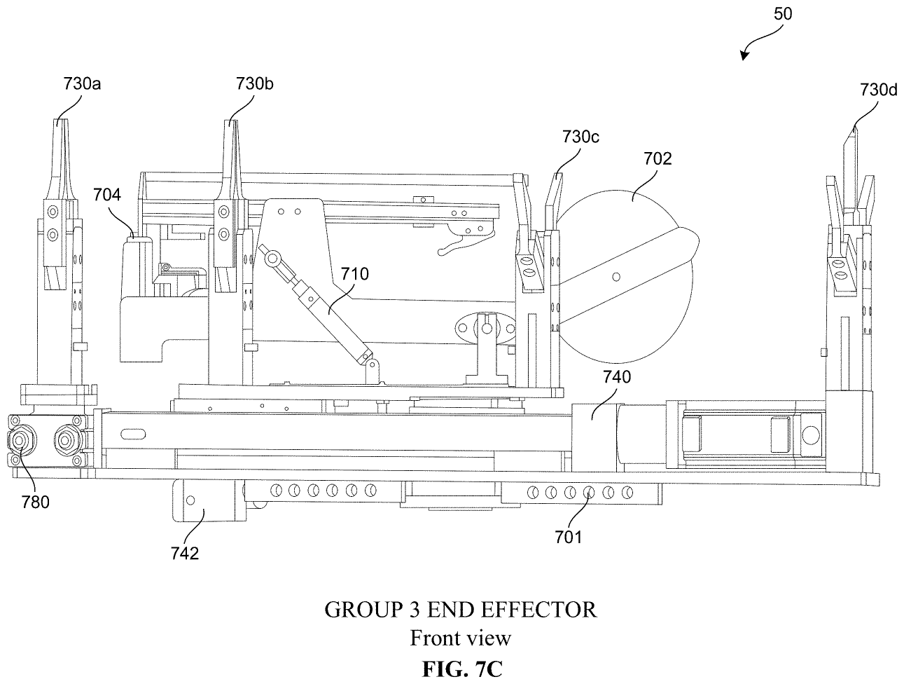

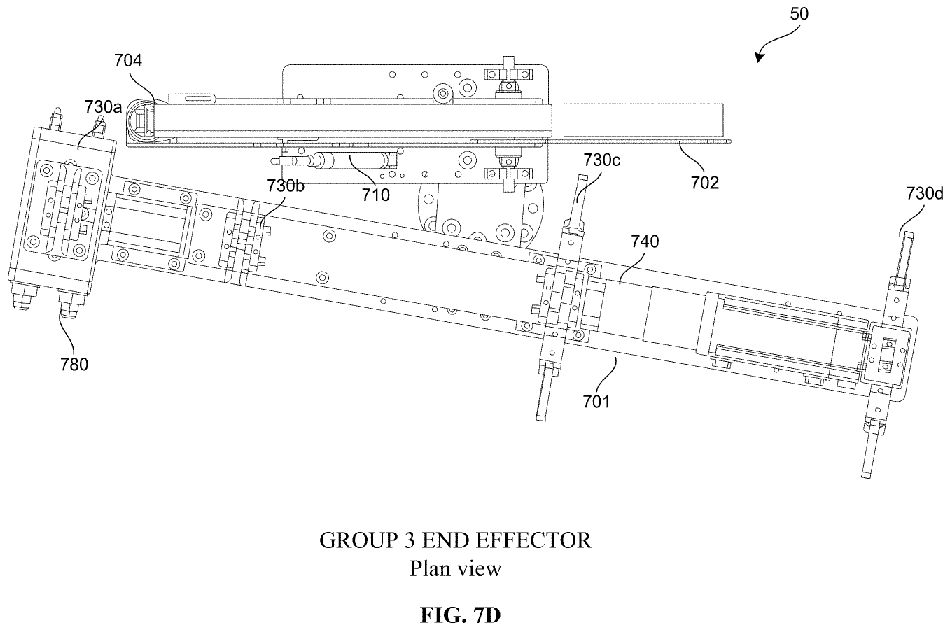

FIGS. 7A, 7B, 7C, and 7D illustrate composite, plan, front and perspective views of an example end effector 50 for group 3 robot 13 of FIG. 1. Now with reference to FIG. 7C, end effector tool 50 includes an adapter plate couplable to an end plate of a robot arm via tool changes (not shown in FIG. 7C); a support structure 701, a fine wire stapler 704 (or other fastener dispenser) having a tab feed mechanism for automatically feeding staples or other fasteners; a storage housing 702 coupled to the stapler 704 for dispensing staples or other fasteners; a stapler (or other fastener) low detection proximity switch (not shown in FIG. 7C); and one or more mechanical gripper(s) 730a, 730b, 730c, and 730d that can be pneumatically actuated facilitating grasping of wrapping material. An air cylinder 710 provides tipping out of stapler 704 enabling the stapler 704 to be positioned in place to insert staples, and removed as needed. Implementations can be configured to include one or more of a vacuum actuated gripper, an adhesive gripper, a magnetic gripper, a servo (electric) gripper, hydraulically actuated gripper, a pneumatically actuated gripper and/or combinations thereof.

With further reference to FIG. 7C, a servo powered linear actuator 740 is disposed along support structure 701 and connected to and between gripper 730a and 730d. Action of actuator 740 permits the distance between gripper 730a and 730d to be varied under control of the wrapping programmable logic controller (PLC). A distance detection device 742 detects positions of one or more of gripper 730a and 730d; thereby enabling the servo actuator 740 to control the distance between gripper 730a and 730d. The function of the servo actuator 740, distance detection device 742 and support structure 701 form a linear rail gripper enabling the wrapping system to accommodate for different package layer heights.

In a presently preferrable implementation, motion and actuation on the end effector depicted in FIG. 7C is pneumatically actuated however, implementations based upon other prime mover(s) that that convert energy from an energy source into motive power may be realized. Fastener types implemented can include, e.g., staples, nails, brads, glues, or other non-threaded fasteners or screw drivers, or other threaded fasteners. Optionally, multiple grippers can be included to accommodate different heights of wood product units.

Noteworthy is that at least one gripper e.g., gripper 730a is capable of rotating +/−90 degrees about its longitudinal axis actuated by gripper rotation assembly 780 that is powered by a pneumatic or other prime mover that that converts energy from an energy source into motive power; thereby facilitating grasping packaging materials in a variety of positions.

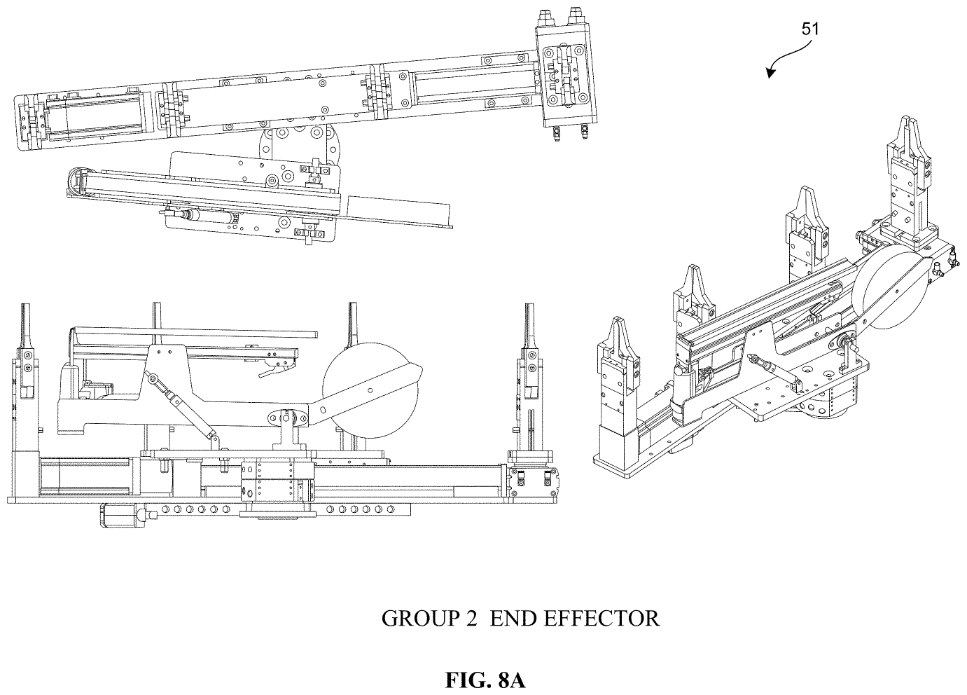

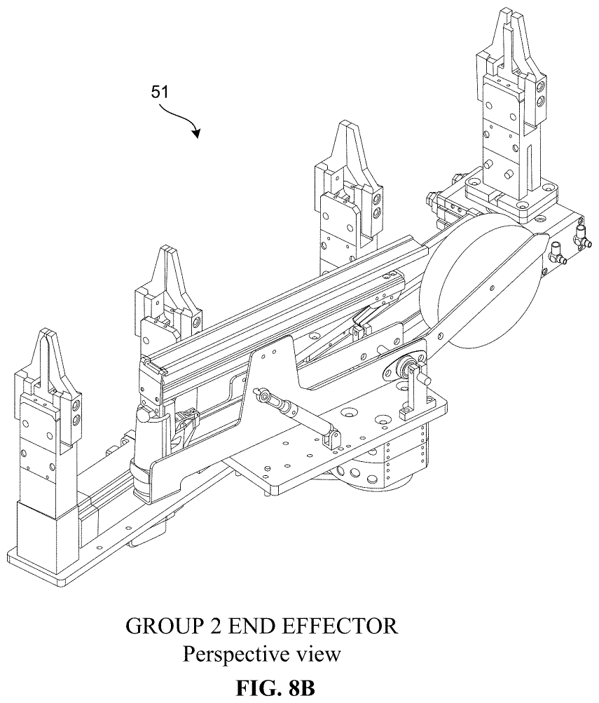

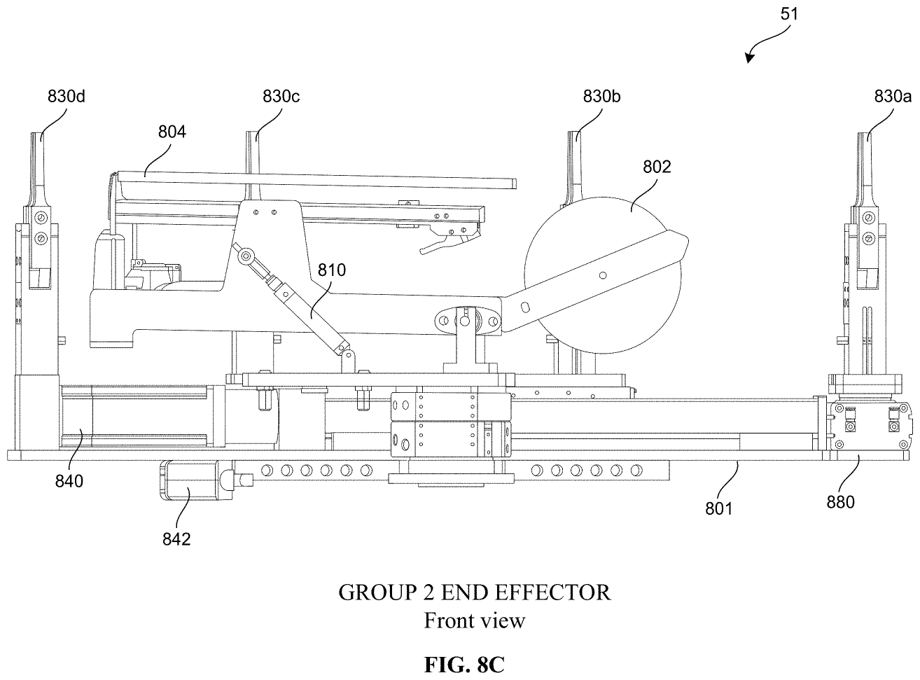

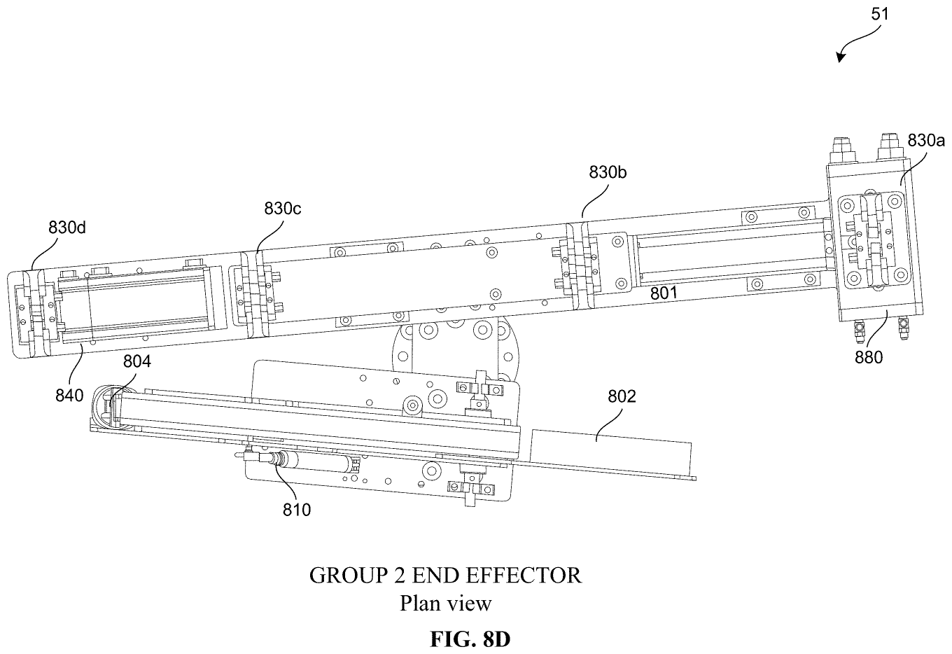

FIGS. 8A, 8B, 8C, and 8D illustrate composite, plan, front and perspective views of an example end effector 51 for group 2 robot 12 of FIG. 1. End effector 51 is depicted in FIG. 8C with like structures having like numerals to those of FIG. 7C. Specifically, with reference to FIG. 8C, end effector tool 51 includes an adapter plate couplable to an end plate of a robot arm via tool changes (not shown in FIG. 8C); a support structure 801, a fine wire stapler 804 (or other fastener dispenser) having a tab feed mechanism for automatically feeding staples or other fasteners; a storage housing 802 coupled to the stapler 804 for dispensing staples or other fasteners; a stapler (or other fastener) low detection proximity switch (not shown in FIG. 8C); and one or more mechanical gripper(s) 830a, 830b, 830c, and 830d that can be pneumatically actuated facilitating grasping of wrapping material. An air cylinder 810 provides tipping out of stapler 804 enabling the stapler 804 to be positioned in place to insert staples, and removed as needed. Implementations can be configured to include one or more of a vacuum actuated gripper, an adhesive gripper, a magnetic gripper, a servo (electric) gripper, hydraulically actuated gripper, a pneumatically actuated gripper and/or combinations thereof.

With further reference to FIG. 8C, a servo powered linear actuator 840 is disposed along support structure 801 and connected to and between gripper 830a and 830d. Action of actuator 840 permits the distance between gripper 830a and 830d to be varied under control of the wrapping programmable logic controller (PLC). A distance detection device 842 detects positions of one or more of gripper 830a and 830d; thereby enabling the servo actuator 840 to control the distance between gripper 830a and 830d. The function of the servo actuator 840, distance detection device 842 and support structure 801 form a linear rail gripper enabling the wrapping system to accommodate for different package layer heights.

In a presently preferrable implementation, motion and actuation on the end effector depicted in FIG. 8C is pneumatically actuated however, implementations based upon other prime mover(s) that that convert energy from an energy source into motive power may be realized. Fastener types implemented can include, e.g., staples, nails, brads, glues, or other non-threaded fasteners or screw drivers, or other threaded fasteners. Optionally, multiple grippers can be included to accommodate different heights of wood product units.

Noteworthy is that at least one gripper e.g., gripper 830a is capable of rotating +/−90 degrees about its longitudinal axis actuated by gripper rotation assembly 880 that is powered by a pneumatic or other prime mover that that converts energy from an energy source into motive power; thereby facilitating grasping packaging materials in a variety of positions.

### Electronics Architecture

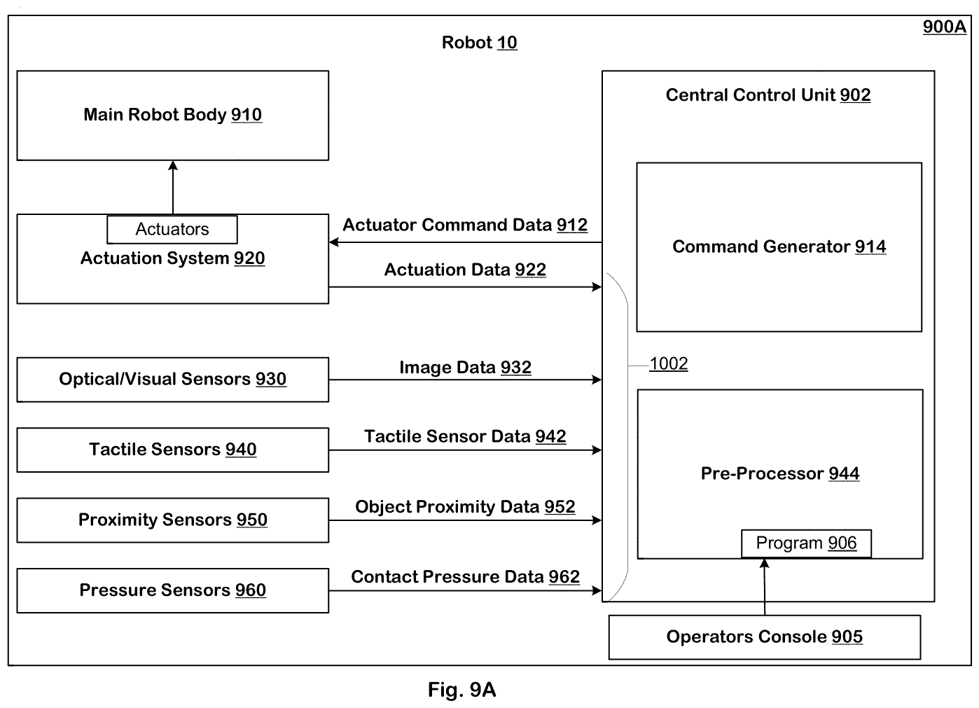

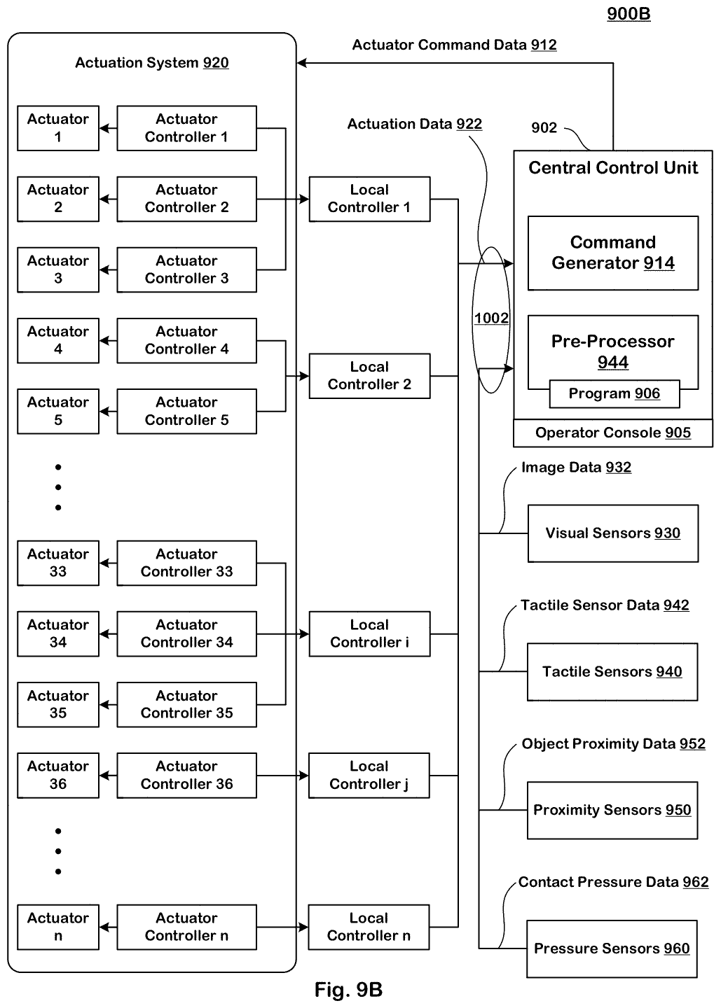

FIG. 9A is a simple functional block diagram of the robot 10. In FIG. 9A, the electronics architecture 900A comprises the central control unit 902 that controls the actuators including sources of motive force and, therefore the linkages, joints, and gripper/end effector, etc. of the robot 10, using the command generator 914 and/or the pre-processor 944.

The robot 10 includes main robot body 910, including the kinematic chain, and the actuation system 920. The robot 10 includes a central control unit 902 (i.e., controller) that in this example comprises a command generator 914 and a pre-processor 944. The controller is in communication with the plurality of actuators and the sensors, and operates the components on the kinematic chain. The controller includes a feedback loop receiving feedback data derived from or including the actuator data and sensor data as feedback input, trained to generate actuator command data 912 to cause the robot to execute a task to manipulate the object responsive to the feedback data, under direct operator control and/or by programmed logic. Implementation specifics vary considerably, however in one example a Controllogix™ PLC is used to implement the robot controller. Training may be implemented using programming by an operator at operators console 905. In other embodiments, machine learning algorithms and techniques are used to generate, or augment existing, commands to the robot 10.

The actuation system 920 can include sources of motive force, e.g., electric motors, hydraulic cylinders, pneumatic cylinders and the like, coupling actuators, e.g., linkages, springs, levers, and so forth, and sensors affixed to one or the other, e.g., encoders, position sensors, combinations thereof, or the like. The actuation system 920 provides actuation data 922 to the central control unit 902, and receives actuator command data 912, including actuator commands, from the central control unit 902. Also, the robot 10 includes as described above, optical / visual sensors 930 generating image data 932 and range data, tactile sensors 940 in this example generating tactile sensor data 942, proximity sensors 950 in this example generating object proximity data 952 relative to the end effectors, and pressure sensors 960 in this example generating contact pressure data 962. The actuation data 922, the image data 932, the tactile sensor data 942, the object proximity data 952, and the contact pressure data 962 are provided to the central control unit 902.

The command generator 914 can plan motion of the robot manipulator and use this motion plan to generate a sequence of commands commanding the joints to for the robot for the purposes of advancing the robot to a goal state provided by the pre-processor 944 to the command generator 914.

The pre-processor 944 can process the actuation data 922, the image data 932, the tactile sensor data 942, the object proximity data 952, and the contact pressure data 962 to produce a state vector for the robot 10. This state vector is produced in a time frame and manner as needed to control the state of the robot 10 and is accessible to task programming provided to the robot 10 via the operators console 905. The pre-processor 944 can include one or more trained neural networks used for the purpose of deriving feedback data for input the neural network that generates the command data. Also, the command generator can include one or more trained neural networks. In some implementations, the command generator and the pre-processor comprise neural networks trained end-to-end using reinforcement learning. Other training procedures can be applied as well, including separate training of the neural networks in the controller.

Thus, the central control unit 902 processes input data comprising at least the actuation data 922 from the actuators of the actuation system 920, the image data 932 from the visual sensors 930 if present, and if present, other sensor data such as the tactile sensor data 942 from the tactile sensors 940 in the right hand end effector 51 and the left hand end effector 50, and generates actuator command data 912.

In some implementations, with reference to FIG. 9B, the electronics architecture 900B further comprises distributed local controllers that are responsible for low-level motor control, including current, velocity, and position control, evaluation of the joint sensors, output control signals to the actuator power electronics, parameterization of the actuator controllers, e.g., for gain scheduling, and data acquisition from the force/torque sensors and inertial measure measurement system. Each local controller can handle a set of actuators (e.g., one, two, or three actuators). Cable harnesses connect the actuator sensors, actuators, drives to the local controllers. The central control unit 902 and the local controllers can communicate by a high speed communication interface such as CAN, FireWire, or SERCOS, supporting real-time control in which each new set of actuator commands is based on feedback data that indicates the effects of the immediately preceding command set on the pose of the robot and the object of the task.

### Controller

The central control unit 902 includes the command generator 914 and the pre-processor 944, in this example, implementing a control loop that includes processing the input data for an instant time interval, and generating the actuator command data 912 for use in a next time interval.

The central control unit 902 is also configured with a system file including a program file (e.g., program file 906) that specifies the task(s) to be executed by the robot 10. The program file can identify the task in a sequence of sub-tasks, along with goal positions, goal angles, maximum and minimum values for sampling the goal positions and the goal angles, policy paths and trajectories, policy speedup coefficients, and feedback actions. Each “task” can be implemented to be triggered based upon a set of detected input conditions, duty cycle, operator command issued at the operators console 905 or otherwise. In one implementation, a set of weights generated by training a neural network system, including a trained neural network in a feedback loop receiving feedback data derived from or including the actuator data and the sensor data as feedback input, trained to generate actuator command data to cause the robot to execute the task to manipulate the object, or the robot in preparation for manipulation of an object, in response to the feedback data. The neural network system that can be trained using reinforcement learning algorithms and configured with a policy that implements the control feedback loop. The neural network system can use neural networks like a multi-layer perceptron (MLP), a feed-forward neural network (FFNN), a fully connected neural network (FCNN), a convolutional neural network (CNN), and a recurrent neural network (RNN). Example of the reinforcement learning algorithms include deterministic policy gradient algorithms, and policy-gradient actor-critic algorithms like deep deterministic policy gradient (DDPG) with hindsight experience replay (HER) and distributed distributional deterministic policy gradient (D4PG).

The input data 1002 can includes the range image data 932 from the visual sensors 930 indicating the orientation and position of the work piece 9 and the end effectors 50, 51 in three dimensions and time, and the actuation data 922 from the actuators of the actuation system 920. The input data 1002 can further include the tactile sensor data 942 from the tactile sensors 940 in right hand end effector 51 and the left hand end effector 50. The input data 1002 can further include the object proximity data 952 from the proximity sensors 950. The input data 1002 can further include the contact pressure data 962 from the pressure sensors 960. The input data 1002 can further include external motion tracking data from an external, stand-alone motion tracking system like OptiTrack™ type motion capture system that tracks motion of the robot 10 and the object in a three-dimensional space. The input data 1002 can be used as feedback data in the feedback loop, and can be used to derive feedback data, and both.

The actuator command data 912 updates one or more of the actuator parameters of the actuators. Examples of the actuator command data 912 include position updates, absolute positions, angle updates, absolute angles, torque updates, absolute torques, speed updates, absolute speeds, velocity updates, absolute velocities, acceleration updates, absolute accelerations, rotation updates, and absolute rotations. The actuator command data 912 is used to update the respective states of the actuators in the next time interval, which in turn causes the tendons, the joints, the body parts, and the robot 10 to transition to a different state (e.g., tension, position, orientation) in the next time interval.

The actuator command data 912 can include commands for each of the actuators or only a subset of the actuators. Each command can include an actuator ID, and a numerical value or values used to drive the actuator to a next state.

In the implementation listed above, the actuator command data 912 provided as output of the controller comprising a vector of drive changes for differential positioning, or a vector of position mode target positions, or a vector of force/torque values, and various combinations of differential mode commands, position mode command as suitable for the actuators under control.

The actuators execute the commands specified in the actuator command data 912 and generate the actuation data 922 for the next time interval, and cause generation of the image data 932 by the visual sensors 930 and the tactile sensor data 942 by the tactile sensors 940 for the next time interval. The process is iterated by the control loop implemented by the controller 930.

In some implementations, the actuator command data 912 generated by the controller 902 is processed by a calibration module (not shown) that generates a calibrated version of the actuator command data 912 which is specific to the configuration of the robot 10. The calibrated version of the actuator command data is used to update the respective states of the actuators.

Additional features included in various implementations of the robotic packaging workstation 14 include the use of sensors such as (i) encoders (4) for paper feed measurement; (ii) current transducers allowing the system to automatically detect a stall or jamb condition of a robot manipulator and signal for assistance; and (ii) area sensors for detection of entry into a danger zone. Additionally, implementations can include the end effector including hardware and control logic in the PLC to implement automatic label placement on the packaged unit. Some implementations can include unit centering to reduce the variation of travel of the robot manipulators to accommodate different unit positionings. Some implementations include lathe breaking. Some implementations will include provisions for automatically reloading the staple or other fasteners.

As mentioned above, multiple robot manipulators (or robotic workstations) can be combined, such that the robot manipulators are spaced apart by, for example 8 feet. For sake of clarity, a single robot workstation can include multiple robot manipulators (e.g., 4 or more), as mentioned above, multiple robotic workstations can be implemented, where each robot workstation includes a more or fewer robot manipulators. The number of robot manipulators is dictated by the maximum dimensions of the product unit. The robot manipulators can be coordinated to perform wrapping and stapling in coordinated moves at the same time. An example system can handle efficiently wrapping/packaging product stacked into units having dimensions of approximately 40″ to 54″ in width, 12″ to 36″ height, and 6′ to 20′ in length. Product unit sizes can be detected using sensors, or optimally received from saw mill floor controllers via wired or wireless network and used to determine where each robot manipulator would need to be positions and the size and quantity of wrapping material to be fee and cut. This information is calculated and then passed from a programmable logic controller (PLC) to each of the robot manipulators for initial positioning and subsequent packaging.

### Some Particular Implementations

We describe various implementations of robotic packaging workstation.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

A system implementation of the technology disclosed includes a robotic workstation for packaging wood products. The robotic packaging workstation can achieve can handle efficiently wrapping/packaging product stacked into units having dimensions of approximately 40″ to 54″ in width, 12″ to 36″ height, and 6′ to 20′ in length. In one configuration, the robotic packaging workstation includes a robot manipulator capable of moving an end effector adapter plate to points in a three-dimensional work volume under programed control of a programmable robot controller executing stored instructions. A fastener and wrapping tool head is affixed to the end effector adapter plate. The fastener and wrapping tool head further includes a support structure, a fastener applicator, a fastener storage, and one or more grippers for grasping wrapping material.

This system implementation and other systems disclosed optionally include one or more of the following features. System can also include features described in connection with methods disclosed. In the interest of conciseness, alternative combinations of system features are not individually enumerated. Features applicable to systems, methods, and articles of manufacture are not repeated for each statutory class set of base features. The reader will understand how features identified in this section can readily be combined with base features in other statutory classes.

One robotic packaging workstation implementation further includes a materials handling system moving work units into the work volume and packaged work units out of the work volume.

One robotic packaging workstation implementation further includes wrapping material feed for feeding wrapping material to the robot manipulators.

One robotic packaging workstation implementation further includes a plurality of encoders for measuring a quantity of wrapping material being fed.

One robotic packaging workstation implementation further includes at least one tool station to receive fastener and wrapping tool heads for attaching by the robot manipulators at the end effector adapter plate.

In one robotic packaging workstation implementation, the fastener and wrapping tool head further includes a sensor indicating an amount of fastener loaded into the fastener storage.

In one robotic packaging workstation implementation, the fastener storage is capable of holding 380 staples.

In one robotic packaging workstation implementation, the fastener storage is capable of holding 500 staples.

One robotic packaging workstation implementation further includes plurality of rails disposed approximately parallel to a path of work units flowing through the workstation and upon which each of the first plurality of robot manipulators is attached; thereby enabling the first plurality of manipulators to traverse a path approximately parallel to the path of work units flowing through the workstation.

An apparatus implementation of the technology disclosed includes fastener and grasping tool for a robotic packaging workstation, that can include an adapter plate couplable to an end plate of a robot arm; a fastener applicator having an automatic feeder; a storage housing coupled to the fastener applicator for dispensing fasteners; a fastenerlow detection proximity switch; and at least one mechanical gripper facilitating grasping of wrapping material.

An apparatus implementation of the technology disclosed includes fastener and grasping tool for a robotic packaging workstation, that can include an adapter plate couplable to an end plate of a robot arm; a stapler having a tab feed mechanism for automatically feeding staples; a storage housing coupled to the stapler for dispensing staples; a stapler low detection proximity switch; and at least one mechanical gripper facilitating grasping of wrapping material.

One fastener and grasping tool for a robotic packaging workstation implementation further includes a mechanism for attaching and detaching the adapter plate from the end plate of the robot arm under control of a programmable logic controller.

One fastener and grasping tool for a robotic packaging workstation implementation further includes multiple grippers that accommodate different heights of product units.

A method implementation of the technology disclosed includes a method of packaging wood product units. The method can include receiving by a Programmable Logic Controller, information identifying a wood product unit to be received, the identifying information comprising selected ones of: a unit length, a unit width, a unit height, a unit ID, a product ID. The method further includes obtaining a portion of wrapping material appropriately sized using the identifying information, to include at least first plurality of robot manipulators grasping an end of the wrapping material, a motor with encoder feedback dispensing a length of wrapping material required to fully wrap the wood product unit, and at least second plurality of robot manipulators grasping a trail end of the wrapping material prior to cutting the wrapping material. At least the first plurality of robot manipulators can perform prepositioning themselves according to size of the wood product unit incoming using the identifying information. The wood product unit is received at a location determined by a presence sensor. The method further includes determining by at least one robot manipulator a measured position of at least one corner of the wood product unit. The method also includes wrapping by the robot manipulators the wood product unit and applying fasteners to hold wrapping material in place. Upon completion of the wrapping, advancing the wood product unit as packaged from an outfeed side of a work envelope using a materials handling system can also be part of the method.

Each of the features discussed in this particular implementation section for the first system implementation apply equally to this method implementation. As indicated above, all the system features are not repeated here and should be considered repeated by reference.

Other implementations may include a non-transitory computer readable storage medium storing instructions executable by a processor to perform a method as described above. Yet another implementation may include a system including memory and one or more processors operable to execute instructions, stored in the memory, to perform a method as described above.

In one implementation of our method, wrapping takes approximately 1 min and 15 seconds from time the wood product unit stops in wrapping position.

In one implementation of our method, height of the wood product unit is within a range of 12″ to 36″.

In one implementation of our method, width of the wood product unit is within a range of 40″ to 54″.

In one implementation of our method, length of the wood product unit is within a range of 6′ to 20′.

In one implementation of our method, the first manipulators are positioned within the robotic packaging workstation based upon a unit length of the wood product unit.

In one implementation of our method, the method further includes cutting the wrapping material.

We claim as follows:

1. A robotic packaging workstation for packaging wood products, the robotic packaging workstation comprising:
a first plurality of robot manipulators positioned at an outfeed end of the robotic packaging workstation and a second plurality of robot manipulators positioned at an infeed end of the robotic workstation; wherein robot manipulators are capable of moving an end effector adapter plate to points in a three-dimensional work volume under programmed control of a programmable robot controller executing stored instructions;
a fastener and wrapping tool head affixed to an end effector adapter plate, the fastener and wrapping tool head further including:
a support structure;
a fastener applicator;
a fastener storage; and
at least one gripper for grasping wrapping material; and
a programmable logic controller implementing control logic to coordinate actions of the first plurality of robot manipulators, the second plurality of robot manipulators and the fastener and wrapping tool head.

2. The robotic packaging workstation according to claim 1, further including:
a materials handling system moving work units into the work volume and packaged work units out of the work volume.

3. The robotic packaging workstation according to claim 1, further including a wrapping material feed for feeding wrapping material to the robot manipulators.

4. The robotic packaging workstation according to claim 3, further including a plurality of encoders for measuring a quantity of wrapping material being fed.

5. The robotic packaging workstation according to claim 1, further including at least one tool station to receive fastener and wrapping tool heads for attaching by the robot manipulators at the end effector adapter plate.

6. The robotic packaging workstation according to claim 1, wherein the fastener and wrapping tool head further includes a sensor indicating an amount of fastener loaded into the fastener storage.

7. The robotic packaging workstation according to claim 1, wherein the fastener storage is capable of holding 380 staples.

8. The robotic packaging workstation according to claim 1, wherein the fastener storage is capable of holding 500 staples.

9. The robotic packaging workstation according to claim 1, further including a plurality of rails disposed approximately parallel to a path of work units flowing through the workstation and upon which each of the first plurality of robot manipulators is attached; thereby enabling the first plurality of manipulators to traverse a path approximately parallel to the path of work units flowing through the workstation.

10. A fastener and grasping tool for a robotic packaging workstation, comprising:
an adapter plate couplable to an end plate of a robot arm;
a stapler having a tab feed mechanism for automatically feeding staples;
a storage housing coupled to the stapler for dispensing staples;
a stapler low detection proximity switch; and
at least one mechanical gripper facilitating grasping of wrapping material.

11. The fastener and grasping tool for a robotic packaging workstation according to claim 10, further including a mechanism for attaching and detaching the adapter plate from the end plate of the robot arm under control of a programmable logic controller.

12. The fastener and grasping tool for robotic packaging workstation according to claim 10, further including multiple grippers that accommodate different heights of product units.

13. A fastener and grasping tool for a robotic packaging workstation, comprising:
an adapter plate couplable to an end plate of a robot arm;
a fastener applicator having an automatic feed;
a storage housing coupled to the fastener for dispensing fastening materials;
a fastener low detection proximity switch; and
at least one mechanical gripper facilitating grasping of wrapping material.

14. A method of packaging wood product units, the method comprising:
receiving by a Programmable Logic Controller, information identifying a wood product unit to be received, the identifying information comprising selected ones of: a unit length, a unit width, a unit height, a unit ID, a product ID;
obtaining a portion of wrapping material appropriately sized using the identifying information, to include at least first plurality of robot manipulators grasping an end of the wrapping material, a motor with encoder feedback dispensing a length of wrapping material required to fully wrap the wood product unit, and at least second plurality of robot manipulators grasping a trail end of the wrapping material;
performing prepositioning at least the first plurality of robot manipulators according to size of the wood product unit incoming using the identifying information;
receiving the wood product unit at a location determined by a presence sensor;
determining by at least one robot manipulator a measured position of at least one corner of the wood product unit;
wrapping by the robot manipulators the wood product unit and applying fasteners to hold wrapping material in place; and
upon completion of the wrapping, advancing the wood product unit as packaged from an outfeed side of a work envelope using a materials handling system.

15. The method according to claim 14, wherein wrapping takes approximately 1 min and 15 seconds from time the wood product unit stops in wrapping position.

16. The method according to claim 14, wherein height of the wood product unit is within a range of 12″ to 36″.

17. The method according to claim 14, wherein width of the wood product unit is within a range of 40″ to 54″.

18. The method according to claim 14, wherein length of the wood product unit is within a range of 6′ to 20′.

19. The method according to claim 14, wherein the first manipulators are positioned within the robotic packaging workstation based upon a unit length of the wood product unit.

20. The method according to claim 14, further including cutting the wrapping material.
